(19) United States
(12) Patent Application Publication
(10) Pub. No.: US 2010/0273440 A1
(43) Pub. Date: Oct. 28, 2010

(54) PORTABLE ELECTRONIC DEVICE HAVING FREQUENCY MODULATION AND MULTIMEDIA BROADCASTING FEATURES

(75) Inventor: WEN-BIN BU, Shenzhen (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/579,780

(22) Filed: Oct. 15, 2009

(30) Foreign Application Priority Data
Apr. 28, 2009 (CN) 200910301919.3

(51) Int. Cl. H04B 1/16

(52) U.S. Cl. 455/142

(57) ABSTRACT

A portable electronic device includes a control unit, an antenna, a switching unit, a multimedia broadcasting unit, a FM unit, and a speaker. The control unit and the antenna are electrically connected to the switching unit. The switching unit is electrically connected to the speaker via the multimedia broadcasting unit and the FM unit. The antenna receives multimedia broadcasting signals and FM signals. The control unit controls the switching unit switch between the multimedia broadcasting unit and the FM unit to receive corresponding signals from the antenna. The speaker outputs the signals from the multimedia broadcasting unit and the FM unit.

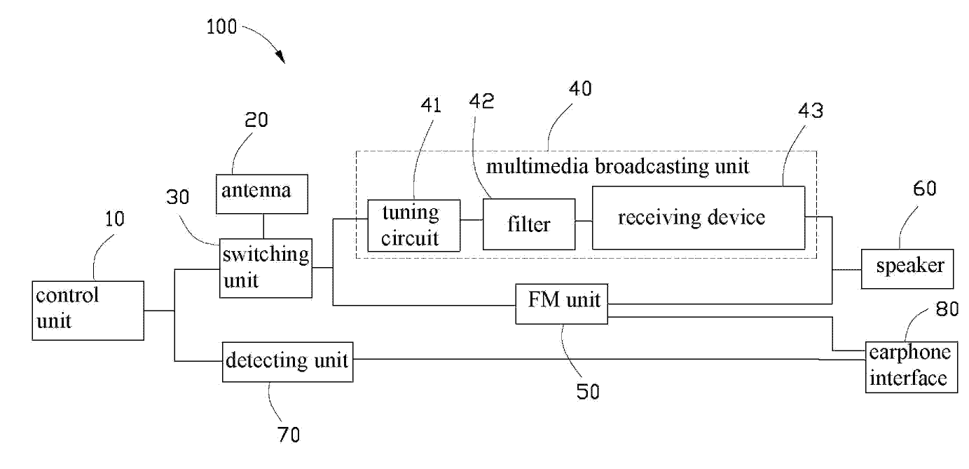

### BACKGROUND

1. Technical Field

The present disclosure generally relates to portable electronic devices, particularly to a portable electronic device having frequency modulation (FM) and multimedia broadcasting features.

2. Description of Related Art

Nowadays, most portable electronic devices such as mobile phones and personal digital assistants (PDAs) are integrated to be multifunctional, such as image capturing, listening to music, etc. The FM function and the multimedia broadcasting function are considered popular features.

Conventional portable electronic devices usually do not have an FM antenna for receiving FM signals. Thus, some conventional portable electronic devices have been equipped with an earphone that serves as an FM antenna to receive the FM signals. When using the FM function, consumers first insert the earphone into an earphone jack of the conventional portable electronic device. Then, the users can use the portable electronic device to receive FM signals and enjoy the FM broadcasting programs. So it is necessary to carry the earphone at all time while using the FM function. In addition, portable electronic devices with multimedia broadcasting function usually have antennas only for receiving multimedia broadcasting signals.

Therefore, there is room for improvement within the art.

### BRIEF DESCRIPTION OF THE DRAWING

Many aspects of the portable electronic device can be better understood with reference to the following drawing. The components in the drawing are not necessarily drawn to scale, the emphasis instead being placed upon clearly illustrating the principles of the portable electronic device.

The drawing shows a block diagram of a portable electronic device, according to an exemplary embodiment.

### DETAILED DESCRIPTION

Referring to the drawing, a portable electronic device 100 includes a control unit 10, an antenna 20, a switching unit 30, a multimedia broadcasting unit 40, a FM unit 50, a speaker 60, a detecting unit 70 and an earphone interface 80. The control unit 10 is electrically connected to the switching unit 30 and the detecting unit 70. The antenna 20 is electrically connected to the multimedia broadcasting unit 40 and the FM unit 50 via the switching unit 30. The multimedia broadcasting unit 40 and the FM unit 50 are electrically connected to the speaker 60. The FM unit 50 and the detecting unit 70 are electrically connected to the earphone interface 80.

The control unit 10 may be a microprocessor in the portable electronic device. The control unit 10 is used to activate the FM function or the multimedia broadcasting function, or switch between the FM function and the multimedia broadcasting function after receiving an operating signal from users via a conventional operating interface such as a keypad. When users activate or switch to the multimedia broadcasting function or the FM function, the control unit 10 sends a control signal to the switching unit 30, and controls the switching unit 30 to switch to the multimedia broadcasting unit 40 or FM unit 50 correspondingly.

The antenna 20 receives the multimedia broadcasting and FM signals from the FM and multimedia broadcasting signals program providers, and sends the FM and multimedia broadcasting signals to the multimedia broadcasting unit 40 and FM unit 50 via the switching unit 20. The antenna 20 may be a telescopic antenna.

The switching unit 30 receives the control signals from the control unit 10, and switches between the multimedia broadcasting unit 40 and the FM unit 50 according to the received control signals. The switching unit 30 may be a relay or a single-pole double-throw switch. When the switching unit 30 receives the control signals from the control unit 10 to switch to the multimedia broadcasting unit 40, the switching unit 30 switches the antenna 20 to electrically connect to the multimedia broadcasting unit 40. When the switching unit 30 receives the control signals from the control unit 10 to switch to the FM unit 50, the switching unit 30 switches the antenna 20 to electrically connect to the FM unit 50.

The multimedia broadcasting unit 40 includes a tuning circuit 41, a filter 42, and a receiving device 43 electrically connected in series. The tuning circuit 41 is connected to the antenna 20 via the switching unit 30. The tuning circuit 41 adjusts the operating frequency of the antenna 20 to receive the multimedia broadcasting signal. The filter 42 reducing noise in the multimedia broadcasting signals, and then sends the multimedia broadcasting signals to the receiving unit 43. The receiving unit 43 is used to search and choose channels of the multimedia broadcasting program, and receive the multimedia broadcasting signals.

The FM unit 50 is a FM microchip capable of searching and choosing channels of the FM broadcasting program. The FM unit 50 receives FM signals from the antenna 20 via the switching unit 30, and sends the FM signals to the speaker 60 and the earphone interface 80.

The detecting unit 70 detects whether an earphone is inserted into the earphone interface 80, and sends a detecting signal to the control unit 10 to use the earphone as the FM antenna to receive FM signals when an earphone is inserted into the earphone interface 80.

In use, users activate the FM function of the portable electronic device 100. The detecting unit 70 detects whether an earphone is inserted into the earphone interface 80. If an earphone is inserted into the earphone interface 80, the control unit 10 controls the FM unit 50 to receive FM signals via the earphone interface 80 by using the earphone as an antenna. If there is no earphone inserted into the earphone interface 80, the control unit 10 controls the switching unit 30 to switch to the FM unit 50. The FM unit 50 receives FM signals from the antenna 20. When users activate the multimedia broadcasting function of the portable electronic device 100, the control unit 10 controls the switching unit 30 switch the antenna 20 to electrically connect to the multimedia broadcasting unit 40.

The portable electronic device 100 switches the antenna 20 between the multimedia broadcasting unit 40 and FM unit 50 to share the antenna 20. Users can use the portable electronic device 100 to listen to FM broadcasting programs without using an earphone.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A portable electronic device, comprising:
a control unit;
an antenna receiving multimedia broadcasting signals and FM signals;
a switching unit;
a multimedia broadcasting unit;
a FM unit; and
a speaker; wherein the control unit and the antenna are electrically connected to the switching unit, the switching unit is electrically connected to the speaker via the multimedia broadcasting unit and the FM unit, the control unit controls the switching unit to switch between the multimedia broadcasting unit and the FM unit to receive corresponding signals from the antenna, and the speaker outputs the signals from the multimedia broadcasting unit and the FM unit.

2. The portable electronic device as claimed in claim 1, further comprising a detecting unit and earphone interface electrically connected to the detecting unit, wherein the detecting unit is connected to the control unit, the earphone interface is connected to the FM unit, the detecting unit detects whether an earphone is inserted into the earphone interface, and when an earphone is inserted into the earphone interface, the detecting unit sends a detecting signal to the control unit, the control unit controls the FM unit to receive FM signals from the earphone interface by using the inserted earphone as a FM antenna.

3. The portable electronic device as claimed in claim 1, wherein the multimedia broadcasting unit includes a tuning circuit, and a receiving device electrically connected to the tuning circuit, the tuning circuit is electrically connected to the switching unit, the receiving device is electrically connected to the speaker, the tuning circuit adjusts the operating frequency of the antenna to receive the multimedia broadcasting signal, the receiving unit searches and chooses channels of the multimedia broadcasting program, and receives the multimedia broadcasting signals correspondingly.

4. The portable electronic device as claimed in claim 3, wherein the multimedia broadcasting unit further includes a filter set between the tuning circuit and the receiving device, the filter reduces the noises in the multimedia broadcasting signals received from the tuning circuit, and then sends the multimedia broadcasting signals to the receiving unit.

5. The portable electronic device as claimed in claim 1, wherein the switching unit is a relay.

6. The portable electronic device as claimed in claim 1, wherein the switching unit is a single-pole double-throw switch.

7. The portable electronic device as claimed in claim 1, wherein the antenna is a telescopic antenna.

8. A portable electronic device, comprising:
a control unit;
an antenna receiving multimedia broadcasting signals and FM signals;
a FM unit; and
an earphone interface; wherein when an earphone is inserted in the earphone interface, the control unit causes the inserted earphone to be used as an FM antenna and when an earphone is not inserted in the earphone interface, the control unit causes the antenna to be used as an FM antenna.

9. The portable electronic device as claimed in claim 8, further comprising a detecting unit set between the control unit and the earphone interface, wherein the detecting unit detects whether an earphone is inserted into the earphone interface, and when an earphone is inserted into the earphone interface, the detecting unit sends a detecting signal to the control unit, the control unit controls the FM unit to receive FM signals from the earphone interface by using the inserted earphone as an FM antenna.

10. The portable electronic device as claimed in claim 8, further comprising a switching unit, a multimedia broadcasting unit and a speaker, the antenna is electrically connected to the multimedia broadcasting unit and the FM unit via the switching unit, the multimedia broadcasting unit and the FM unit are electrically connected to the speaker, the control unit controls the switching unit to switch to the multimedia broadcasting unit or the FM unit.
